(19) United States
(12) Patent Application Publication
(10) Pub. No.: US 2004/0180992 A1
(43) Pub. Date: Sep. 16, 2004

(54) Epoxy resin compositions

(75) Inventors: Martin Gerlitz, Graz (AT); Andreas Gollner, Graz (AT); Thomas Fischer, Graz (AT)

Correspondence Address: CONNOLLY BOVE LODGE & HUTZ, LLP, P O BOX 2207, WILMINGTON, DE, 19899, US

(73) Assignee: Surface Specialties Austria GmbH

(21) Appl. No.: 10/798,030

(22) Filed: Mar. 11, 2004

(30) Foreign Application Priority Data
Mar. 12, 2003 (AT) 393/2003

(51) Int. Cl. C08L 63/00

(52) U.S. Cl. 523/400

(57) ABSTRACT

An epoxy resin composition comprising an addition polymer BC of vinyl monomers B, which is polymerized in the presence of liquid epoxy resins C, and, if desired, further liquid epoxy resins A, curatives, and, if desired, fillers, process for its preparation, and its use for coating painted and unpainted metals, especially in thick coats

### FIELD OF THE INVENTION

The invention relates to epoxy resin compositions.

### BACKGROUND OF THE INVENTION

Epoxy resin compositions can be in the form of solutions in suitable solvents, aqueous dispersions or emulsions, or in undiluted form (“bulk” or “neat”). In the case of solvent-borne application forms or in the case of aqueous emulsions or dispersions it is necessary for the solvent or water to evaporate following application. This additional step in the application is time-consuming, technically disruptive, and complicated, since the solvent vapors, for example, must not be emitted to the environment. For high-build applications in particular it is a disadvantage if solvents or water have to escape from the applied coat in the course of film formation. Without modification, epoxy resins are hard and brittle; modification with aliphatic polyethers leads to more elastic systems, but these have an impaired stability toward solvents or water.

Elastic epoxy resin compositions modified with aliphatic polyetheramines have been known from EP-A 0 658 584. They have the drawback, however, that their chemical resistance and solvent resistance, particularly at elevated temperature (40 to 60° C. for example), is still not satisfactory.

### SUMMARY OF THE INVENTION

It is therefore an object of the invention to provide epoxy resin compositions which can be applied in relatively thick coats of preferably from 0.5 to 5 mm to a substrate and lead to coatings having elastic properties and combining good adhesion with good chemical resistance.

This object is achieved by the epoxy resin compositions of the invention.

The invention provides an epoxy resin composition comprising an addition polymer BC of vinyl monomers, which is polymerized in the presence of liquid epoxy resins C, and, if desired, further liquid epoxy resins A.

The invention further provides a process for preparing the epoxy resin compositions of the invention.

The invention further provides epoxy resin compositions further comprising fillers.

The invention finally provides for the use of the epoxy resin compositions of the invention, preferably as high-build coating compositions for the coating of substrates in coat thicknesses of preferably from 0.5 to 5 mm.

### DETAILLED DESCRIPTION OF THE PREFERRED EMBODIMENTS

The liquid epoxy resins A and C can be identical or different and are selected independently of one another from aromatic and aliphatic epoxy resins based on glycidyl ethers of monohydric or polyhydric phenols or alcohols and glycidyl esters of aromatic or aliphatic carboxylic acids, especially dicarboxylic acids. Their viscosity, determined in accordance with DIN EN ISO 3219 at 23° C. and a shear rate of 100 s⁻¹, ought preferably to be from 5 to 20 000 mPa·s. Preference is given to liquid resins based on glycidyl esters especially of dibasic aliphatic carboxylic acids and on glycidyl ethers of bisphenol A (BADGE) or preferably monohydric or polyhydric aliphatic alcohols and especially polypropylene glycol, in each case having a specific epoxide group content of from 0.5 to 10 mol/kg, preferably from 1 to 8 mol/kg, and more preferably from 2.5 to 7 mol/kg.

The addition polymers BC of vinyl monomers which are polymerized in the presence of the epoxy resins C are derived from mixtures of vinyl monomers B which include at least one acid-functional vinyl monomer B1 and at least one further vinyl monomer selected from aliphatic monomers B2 which contain no functional group other than the olefinically unsaturated group, aromatic vinyl monomers B4, and monomers B3 containing hydroxyl groups. Suitable monomers B1 are olefinically unsaturated monocarboxylic acids having 3 to 10 carbon atoms, such as acrylic acid, methacrylic acid, vinyl-acetic acid, crotonic acid, and isocrotonic acid, and monoesters of olefinically unsaturated dicarboxylic acids with aliphatic linear, branched or cyclic alcohols, such as monomethyl maleate or monomethyl fumarate. Suitable monomers B2 are the alkyl esters of methacrylic acid and acrylic acid and also the dialkyl esters of maleic acid and fumaric acid, the alkyl groups being linear, branched or cyclic and having from 1 to 20 carbon atoms. Preference is given to methyl(meth)acrylate, ethyl(meth)acrylate, the isomeric butyl (meth)acrylates, 2-ethylhexyl(meth)acrylate, and (iso)bornyl(meth)acrylate. Suitable monomers B3 are 2-hydroxyethyl(meth)acrylate, 2-hydroxypropyl (meth)acrylate, and 1-hydroxyisopropyl(meth)acrylate. Suitable aromatic vinyl monomers B4 besides styrene are the substituted styrenes such as p-methylstyrene, vinyltoluene, chlorostyrene and alpha-methylstyrene.

Where the addition polymers BC are used alone their viscosity at room temperature (23° C.) is preferably between 1 000 and 10 000 mPa·s, more preferably between 1 500 and 8 000 mPa·s, and in particular between 2 000 and 7 000 mPa·s. The specific epoxide group content of the addition polymers BC is preferably from 1 to 8 mol/kg, more preferably from 2 to 5 mol/kg.

The amounts of B and C and the composition of the monomer mixture B are preferably chosen such that the ratio of the amount of substance of carboxyl groups of the monomers B1 to the amount of substance of the epoxide groups in C is from 5 to 15%, more preferably from 6 to 12%. The ratio of the masses B and C is preferably from 3:1 to 1.1:1, more preferably from 2.5:1 to 1.2:1. The composition of the mixtures ABC is chosen such that the viscosity of the mixture of component A with component BC at 23° C. is preferably between 1 000 and 10 000 mPa·s, more preferably between 1 500 and 8 000 mPa·s, and in particular between 2 000 and 7 000 mPa·s. Since the viscosity of component A may be very much lower it is possible when admixing A to use relatively high molar mass addition polymers BC which have more favorable mechanical properties. The specific epoxide group content of the mixtures ABC is preferably from 1 to 8 mol/kg, more preferably from 2 to 5 mol/kg.

The addition polymers BC can be prepared by mixing a liquid epoxy resin C with olefinically unsaturated monomers B which include at least one monomer B1 selected from olefinically unsaturated carboxylic acids having from 3 to 10 carbon atoms. The polymerization of the monomers is preferably triggered by addition of free radical initiators such as peroxides or aliphatic azo compounds which decompose at elevated temperature to form free radicals in a known way. The preferred temperature range is 100 to 160° C. After mixing and in the course of the polymerization reaction the acids may react with the epoxides to form hydroxy esters, thereby chemically linking the components of the addition polymer BC. After the end of the polymerization reaction it is possible with preference to mix further epoxide compounds A into the addition polymer BC.

If both A and C are used, it is preferred that A is an aliphatic epoxy resin if C is an aromatic epoxy resin, and vice versa.

The epoxy resin compositions (addition polymers BC or mixtures ABC) can be cured thermally in a conventional manner by adding acids or anhydrides, amines, or what are known as latent curatives. Curing is preferably carried out with latent curatives, in particular of dicyandiamide, since this allows one-component compositions to be formulated with no substantial limitation in pot life.

The mass fraction of curative chosen is between 0.1% and 20%, preferably from 0.5 to 10%, based on the sum of the masses of epoxy resin composition and curative. Where appropriate it is also possible to add curing accelerators, examples being imidazole derivatives or tertiary aliphatic amines.

The epoxy resin compositions may further comprise additional fillers, such as talc, calcined kaolins, silicates, chalk, dolomite, graphite, mica, metal powders, glass fibers and ground glass, silica, especially highly disperse silica, and bentonites. Preferred fillers are those whose particle size is not more than 200 μm, the fillers present comprising at least one substance selected from aluminum powder and zinc powder, graphite powder and mica powder or mixtures of these fillers. Preference is given to the combination of aluminum powder or zinc powder, graphite or mica, and, if desired, talc or chalk.

The mass fraction of fillers is at least 18% and preferably up to 80%. The mass fraction of the aluminum or zinc powder is in the range from 1 to 8%, that of the graphite or mica in the range from 10 to 50%. The materials of the invention can also be admixed with pigments such as titanium dioxide, carbon black, and iron oxide pigments, and also with organic pigments such as azo pigments and phthalocyanine pigments.

The filled or unfilled materials formulated in this way can be sprayed onto the substrates in a coat thickness of preferably from 0.5 to 5 mm at temperatures of up to 140° C. and adhere outstandingly well to painted and unpainted metal sheets which are used, for example, for vehicles, especially automobiles, and household appliances.

### EXAMPLES

The examples which follow illustrate the invention. The viscosities measured were determined in accordance with DIN EN ISO 32190 at 23° C. and a shear rate of 1 s⁻¹.

### Example 1

150 g of a liquid epoxy resin based on bisphenol A with a specific epoxide group content of 5.4 mol/kg and 50 g of xylene were charged to a reaction vessel and heated to reflux temperature (about 140 to 145° C.). Over the course of three hours a mixture of

| | |
|---|---|
| 55 g | of methyl methacrylate |
| 10 g | of butyl acrylate, |
| 40 g | of styrene |
| 5 g | of acrylic acid, and |
| 1.5 g | of di-tert.-butyl peroxide |

was added dropwise at a uniform rate. After the end of the addition a further 0.2 g of di-tert.-butyl peroxide was added and the mixture was held at the same temperature for two hours. Distillation under reduced pressure at 150° C. removed residual monomers and the xylene solvent; 200 g of a diglycidyl ether of polypropylene glycol (specific epoxide group content: 3.1 mol/kg) were added to the cooled mixture. The viscosity of the mixture was 2 200 mPa·s, while the specific epoxide group content measured was 3.0 mol/kg.

### Example 2

The procedure of example 1 was repeated but with initial introduction of 200 g of a diglycidyl ether of polypropylene glycol (specific epoxide group content: 3.1 mol/kg) and without dilution with xylene. Following removal of the residual monomers by distillation under reduced pressure as in example 1, in this case 150 g of the liquid epoxy resin of Example 1 based on bisphenol A with a specific epoxide group content of 5.4 mol/kg were added. The viscosity of the mixture was about 6 000 mPa·s; the specific epoxide group content measured was 2.9 mol/kg.

### Example 3

100 g of each of the mixtures from examples 1 and 2 were mixed with 3 g of dicyandiamide and 100 g of ground chalk (particle size: less than 50 μm) in a kneader apparatus. The resin/curative mixture was sprayed at 80° C. onto an uncoated steel panel, with a film thickness of 3 mm. After about 30 minutes at 200° C. the mixtures had set. Adhesion to the panels was excellent. In a bending test at −20° C. the coating cracked at the bending sites but did not detach from the panel. At room temperature and even at elevated temperature (60° C.) the coatings were highly resistant to water, dilute alkalis and acids, salt solutions, and solvents. Additionally, bright metal panels were coated with a 2.5 mm film of the resin/curative mixture and subjected to a condensation test (tropical test, DIN 50 017 or ISO 6270). Even after 500 hours of treatment there was no corrosion to be detected. Bright metal panels coated in the same way were subjected to the salt spray test (ISO 7253). After 500 hours of treatment (at which point the test was terminated) there was no corrosion to be detected.

### Example 4

The mixtures from example 3 were further admixed with 0.2 g of ®Curezol C17C accelerator (an imidazoline derivative) and the materials were mixed in a kneader. The composition obtained was sprayed at 80° C. onto uncoated steel panels. After curing (30 minutes at 170° C.), adhesion to the panel was found to be excellent; in the bending test at room temperature (23° C.) and at −20° C. the coating did not flake off the substrate. At room temperature and even at elevated temperature (60° C.) the coating was highly resistant to water, dilute alkalis and acids, salt solutions, and solvents. Additionally, bright metal panels were coated with a 2.5 mm film of the resin/curative mixture and subjected to a condensation test (tropical test, DIN 50 017 or ISO 6270). Even after 500 hours of treatment there was no corrosion to be detected. Bright metal panels coated in the same way were subjected to the salt spray test (ISO 7253). After 500 hours of treatment (at which point the test was terminated) there was no corrosion to be detected.

What is claimed is:

1. An epoxy resin composition comprising an addition polymer BC of vinyl monomers B, which is polymerized in the presence of liquid epoxy resins C, and, if desired, further liquid epoxy resins A.

2. The epoxy resin composition as claimed in claim 1, wherein the liquid epoxy resins A and C are selected independently of one another from glycidyl esters of aliphatic monobasic or polybasic carboxylic acids and glycidyl ethers of aliphatic monohydric or polyhydric alcohols and phenols having a specific epoxide group content of from 0.5 to 10 mol/kg.

3. The epoxy resin composition as claimed in claim 1, wherein the addition polymer BC is derived from vinyl monomers containing acid groups.

4. The epoxy resin composition as claimed in claim 1, wherein the addition polymer BC is derived from monomers B1 selected from olefinically unsaturated carboxylic acids having from 3 to 10 carbon atoms.

5. The epoxy resin composition as claimed in claim 4, wherein the addition polymer is derived from further vinyl monomers selected from monomers B2 without further functionality, hydroxy-functional monomers B3, and aromatic vinyl monomers B4.

6. The epoxy resin composition as claimed in claim 1, having a viscosity, measured in accordance with DIN EN ISO 3219 at 23° C. and 100 s⁻¹, of from 1 000 to 10 000 mPa·s.

7. The epoxy resin composition as claimed in claim 1, further comprising fillers selected from talc, calcined kaolins, silicates, chalk, dolomite, graphite, mica, metal powders, glass fibers and ground glass, silica, especially highly disperse silica, and bentonites.

8. A process for preparing an epoxy resin composition as claimed in claim 1, which comprises preparing a polymer BC in the presence of a liquid epoxy resin C by radical polymerization of vinyl monomers B including acid-functional vinyl monomers B1.

9. The process as claimed in claim 8, wherein the polymer BC is mixed with a liquid epoxy resin A.

10. A method of use of an epoxy resin composition as claimed in claim 1 for coating painted or unpainted metals, comprising preparing an epoxy resin composition as claimed in claim 1 and applying the said epoxy resin composition to a painted or unpainted metal substrate.
